(19) United States
(12) Patent Application Publication
(10) Pub. No.: US 2025/0141591 A1
(43) Pub. Date: May 1, 2025

(54) RATE MATCHING FOR CELL DISCONTINUOUS RECEPTION OR DISCONTINUOUS TRANSMISSION

(71) Applicant: QUALCOMM Incorporated, San Diego, CA (US)

(72) Inventors: Ahmed Attia ABOTABL, San Diego, CA (US); Diana MAAMARI, San Diego, CA (US)

(21) Appl. No.: 18/498,136

(22) Filed: Oct. 31, 2023

(51) Int. Cl. H04L 1/00; H04W 76/27; H04W 76/28

(52) U.S. Cl. CPC H04L 1/0013; H04W 76/28; H04W 76/27

(57) ABSTRACT

Various aspects of the present disclosure generally relate to wireless communication. In some aspects, a user equipment (UE) may receive first information corresponding to an active period of cell discontinuous transmission (DTX) or discontinuous reception (DRX) operation and second information corresponding to a non-active period of the cell DTX or DRX operation. The UE may rate match during the non-active period using the second information. Numerous other aspects are described.

### INTRODUCTION

Aspects of the present disclosure generally relate to wireless communication and to techniques and apparatuses for discontinuous reception or discontinuous transmission.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving first information corresponding to an active period of cell discontinuous transmission (DTX) or discontinuous reception (DRX) operation and second information corresponding to a non-active period of the cell DTX or DRX operation. The method may include rate matching during the non-active period using the second information.

Some aspects described herein relate to a method of wireless communication performed by a network entity. The method may include transmitting first information for an active period of cell DTX or DRX operation and second information for a non-active period of the cell DTX or DRX operation. The method may include rate matching during the non-active period using the second information.

Some aspects described herein relate to a method of wireless communication performed by a UE. The method may include receiving a first gap measurement configuration for measurement during an active period of cell DTX or DRX operation of a first cell and a second gap measurement configuration for measurement during a non-active period of the cell DTX or DRX operation of the first cell. The method may include measuring, during the non-active period using the second gap measurement configuration, a signal of a second cell during a gap in signals of the first cell.

Some aspects described herein relate to a method of wireless communication performed by a network entity. The method may include transmitting a first gap measurement configuration for measurement during an active period of cell DTX or DRX operation of a first cell and a second gap measurement configuration for measurement during a non-active period of the cell DTX or DRX operation of the first cell. The method may include receiving, after being in the non-active period, a measurement of a signal of a second cell.

Some aspects described herein relate to an apparatus for wireless communication at a UE. The apparatus may include one or more memories and one or more processors coupled to the one or more memories. The one or more processors may be configured to receive first information corresponding to an active period of cell DTX or DRX operation and second information corresponding to a non-active period of the cell DTX or DRX operation. The one or more processors may be configured to rate match during the non-active period using the second information.

Some aspects described herein relate to an apparatus for wireless communication at a network entity. The apparatus may include one or more memories and one or more processors coupled to the one or more memories. The one or more processors may be configured to transmit first information for an active period of cell DTX or DRX operation and second information for a non-active period of the cell DTX or DRX operation. The one or more processors may be configured to rate match during the non-active period using the second information.

Some aspects described herein relate to an apparatus for wireless communication at a UE. The apparatus may include one or more memories and one or more processors coupled to the one or more memories. The one or more processors may be configured to receive a first gap measurement configuration for measurement during an active period of cell DTX or DRX operation of a first cell and a second gap measurement configuration for measurement during a non-active period of the cell DTX or DRX operation of the first cell. The one or more processors may be configured to measure, during the non-active period using the second gap measurement configuration, a signal of a second cell during a gap in signals of the first cell.

Some aspects described herein relate to an apparatus for wireless communication at a network entity. The apparatus may include one or more memories and one or more processors coupled to the one or more memories. The one or more processors may be configured to transmit a first gap measurement configuration for measurement during an active period of cell DTX or DRX operation of a first cell and a second gap measurement configuration for measurement during a non-active period of the cell DTX or DRX operation of the first cell. The one or more processors may be configured to receive, after being in the non-active period, a measurement of a signal of a second cell.

Some aspects described herein relate to a non-transitory computer-readable medium that stores a set of instructions for wireless communication by a UE. The set of instructions, when executed by one or more processors of the UE, may cause the UE to receive first information corresponding to an active period of cell DTX or DRX operation and second information corresponding to a non-active period of the cell DTX or DRX operation. The set of instructions, when executed by one or more processors of the UE, may cause the UE to rate match during the non-active period using the second information.

Some aspects described herein relate to a non-transitory computer-readable medium that stores a set of instructions for wireless communication by a network entity. The set of instructions, when executed by one or more processors of the network entity, may cause the network entity to transmit first information for an active period of cell DTX or DRX operation and second information for a non-active period of the cell DTX or DRX operation. The set of instructions, when executed by one or more processors of the network entity, may cause the network entity to rate match during the non-active period using the second information.

Some aspects described herein relate to a non-transitory computer-readable medium that stores a set of instructions for wireless communication by a UE. The set of instructions, when executed by one or more processors of the UE, may cause the UE to receive a first gap measurement configuration for measurement during an active period of cell DTX or DRX operation of a first cell and a second gap measurement configuration for measurement during a non-active period of the cell DTX or DRX operation of the first cell. The set of instructions, when executed by one or more processors of the UE, may cause the UE to measure, during the non-active period using the second gap measurement configuration, a signal of a second cell during a gap in signals of the first cell.

Some aspects described herein relate to a non-transitory computer-readable medium that stores a set of instructions for wireless communication by a network entity. The set of instructions, when executed by one or more processors of the network entity, may cause the network entity to transmit a first gap measurement configuration for measurement during an active period of cell DTX or DRX operation of a first cell and a second gap measurement configuration for measurement during a non-active period of the cell DTX or DRX operation of the first cell. The set of instructions, when executed by one or more processors of the network entity, may cause the network entity to receive, after being in the non-active period, a measurement of a signal of a second cell.

Some aspects described herein relate to an apparatus for wireless communication. The apparatus may include means for receiving first information corresponding to an active period of cell DTX or DRX operation and second information corresponding to a non-active period of the cell DTX or DRX operation. The apparatus may include means for rating matching during the non-active period using the second information.

Some aspects described herein relate to an apparatus for wireless communication. The apparatus may include means for transmitting first information for an active period of cell DTX or DRX operation and second information for a non-active period of the cell DTX or DRX operation. The apparatus may include means for rating matching during the non-active period using the second information.

Some aspects described herein relate to an apparatus for wireless communication. The apparatus may include means for receiving a first gap measurement configuration for measurement in an active period of cell DTX or DRX operation of a first cell and a second gap measurement configuration for measurement a non-active period of the cell DTX or DRX operation of the first cell. The apparatus may include means for measuring, during the non-active period using the second gap measurement configuration, a signal of a second cell during a gap in signals of the first cell.

Some aspects described herein relate to an apparatus for wireless communication. The apparatus may include means for transmitting a first gap measurement configuration for measurement during an active period of cell DTX or DRX operation of a first cell and a second gap measurement configuration for measurement during a non-active period of the cell DTX or DRX operation of the first cell. The apparatus may include means for receiving, after being in the non-active period, a measurement of a signal of a second cell.

Aspects generally include a method, apparatus, system, computer program product, non-transitory computer-readable medium, user equipment, base station, network entity, network node, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of cell discontinuous transmission (DTX) and/or discontinuous reception (DRX), in accordance with the present disclosure.

FIG. 5A and FIG. 5B are diagrams illustrating an example of rate matching for a non-active period, in accordance with the present disclosure.

FIG. 6A and FIG. 6B are diagrams illustrating examples of gap measurements, in accordance with the present disclosure.

FIG. 7 is a diagram illustrating an example process performed, for example, at a UE or an apparatus of a UE, in accordance with the present disclosure.

FIG. 8 is a diagram illustrating an example process performed, for example, at a network entity or an apparatus of a network entity, in accordance with the present disclosure.

FIG. 9 is a diagram illustrating an example process performed, for example, at a UE or an apparatus of a UE, in accordance with the present disclosure.

FIG. 10 is a diagram illustrating an example process performed, for example, at a network entity or an apparatus of a network entity, in accordance with the present disclosure.

FIG. 11 is a diagram of an example apparatus for wireless communication, in accordance with the present disclosure.

FIG. 12 is a diagram illustrating an example of a hardware implementation for an apparatus employing a processing system, in accordance with the present disclosure.

FIG. 13 is a diagram illustrating an example of an implementation of code and circuitry for an apparatus, in accordance with the present disclosure.

FIG. 14 is a diagram of an example apparatus for wireless communication, in accordance with the present disclosure.

FIG. 15 is a diagram illustrating an example of a hardware implementation for an apparatus employing a processing system, in accordance with the present disclosure.

FIG. 16 is a diagram illustrating an example of an implementation of code and circuitry for an apparatus, in accordance with the present disclosure.

### DETAILED DESCRIPTION

Power consumption accounts for a large percentage of network costs, and most network power consumption comes from a radio access network (RAN). A network entity of the RAN may operate to conserve power. In some examples, to conserve power, the network entity may use a cell discontinuous transmission (DTX) mode. The cell DTX mode includes periodic DTX cycles, where each DTX cycle includes an active period during which the network entity uses power for transmission and a non-active period during which the network entity reduces its power consumption and does not transmit signals (or does not transmit certain signals). The active period may also be referred to as an “active duration” or an “active time”. The non-active period may also be referred to as an “inactive period,” a “non-active duration,” an “inactive duration,” or an “non-active period.” The network entity may also use a cell discontinuous reception mode (DRX) mode that includes periodic DRX cycles, where each DRX cycle includes an active period during which the network entity uses power for monitoring and reception and non-active period during which the network entity reduces its power consumption and does not monitor for and receive signals (or does not receive certain signals). In an example, the active period may include when a network entity is active during a DRX or DTX cycle of a cell DTX/DRX mode. Additionally or alternatively, the active period may include when the network entity is active during another mode or operation that may not be a DRX or DTX cycle of a cell DTX/DRX mode. The non-active period may include when the network entity is not active during a DRX or DTX cycle of a cell DTX/DRX mode. Additionally, or alternatively, the non-active period may include when the network entity is not active during another mode or operation that may not be a DRX or DTX cycle of a cell DTX/DRX mode.

In some examples, when the network entity is in a non-active period, the network entity may enter a sleep state. Sleeping may involve turning off a radio and one or more other components or functions. Turning off or switching off a radio may include removing power from the radio such that the radio is not fully operating or operating with a lower power. The network entity may wake up for an active period. Waking up may involve turning on a radio and one or more other components or functions. Turning on or switching on a radio may include increasing power to the radio such that the radio is fully operating or operating with full power.

A user equipment (UE) may conform its communication to the cell DTX/DRX mode of the network entity. For example, the UE may not transmit to the network entity during a non-active period of a cell DRX mode of the network entity, or monitor for communications from the network entity during a non-active period of a cell DTX mode of the network entity.

In some examples, during the non-active period of a cell DTX/DRX mode, the UE may be expected to drop the use of some physical channels or signals. Dropping the use of some physical channels or signals may reduce the complexity at the UE or improve system performance of the UE. For example, for downlink communications, the UE may drop reception of a physical downlink control channel (PDCCH) in a type-3 common search space (CSS), a semi-persistent scheduling (SPS) communication, a channel state information (CSI) reference signal (CSI-RS) for generating CSI, and/or a CSI-RS for propagation delay compensation, among other examples. Additionally, or alternatively, for uplink communications, the UE may drop transmission of a scheduling request (SR), a configured grant (CG) communication, and/or CSI feedback, among other examples.

Because different channels or signals will be used or dropped (e.g., not allowed or absent) during a non-active period of a cell DTX/DRX mode, some operations at the UE may have different efficiencies during a non-active period than during an active period. One of these operations may include rate matching. Rate matching is used by a UE or a network entity when preparing a signal for transmission. Rate matching may involve adapting an output data rate of an encoder to match available resources for transmission in the time-frequency grid of resource elements of a physical channel. Additionally, or alternatively, rate matching may include assigning data for transmission in a pattern of resource elements so as to avoid transmission in specific resource elements. The pattern may be referred to as “a rate matching pattern.” If rate matching is performed by a UE with the same rate matching pattern during a non-active period of a cell DTX/DRX mode as during an active period of a cell DTX/DRX mode, the rate matching during the non-active period may underuse or overuse resource elements because the rate matching may not account for dropped signals or channels. Such inefficient resource allocation wastes signaling resources, reduces reliability, and increases latency. Other operations may include the UE's behavior during retransmission, reporting channel state information (CSI) feedback, and UE positioning.

According to various aspects described herein, a UE may perform rate matching during a non-active period of cell DTX/DRX operation (e.g., a cell DTX mode or a cell DRX mode) differently than during an active period of cell DTX/DRX operation. For example, the UE may receive, from a network entity, first information corresponding to an active period of cell DTX/DRX operation and second information corresponding to a non-active period of the cell DTX/DRX operation. The first information and the second information may include, for example, rate matching configurations or groups of rate matching patterns (rate matching pattern groups). The UE may use the first information when rate matching data for transmissions to the network entity during active periods of cell DTX/DRX operation and use the second information when rate matching during non-active periods of cell DTX/DRX operation. By rate matching during cell DTX/DRX non-active periods differently than during cell DTX/DRX non-active periods, the UE may improve reliability and improve resource allocation efficiency, which conserves signaling resources and avoids increasing latency.

In some scenarios, a UE may obtain reference signal measurements from another cell during a gap in communications with a network entity. In some aspects, the UE may perform gap measurements differently for cell DTX/DRX non-active periods than for cell DTX/DRX active periods. A gap measurement configuration may indicate when to take measurements, how many measurements, and/or what signals to measure (e.g., inter-frequency, intra-frequency, inter-RAT). The network entity may transmit a first gap measurement configuration for use during active periods and a second gap measurement configuration to use during non-active periods. For example, the UE may perform inter-frequency measurements only during in non-active periods as there may be no heavy interruption of data unlike during active periods. By using a different gap measurement configuration for non-active periods than for active periods, the UE may account for different amounts of data interruptions and may obtain accurate measurements without being interrupted.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

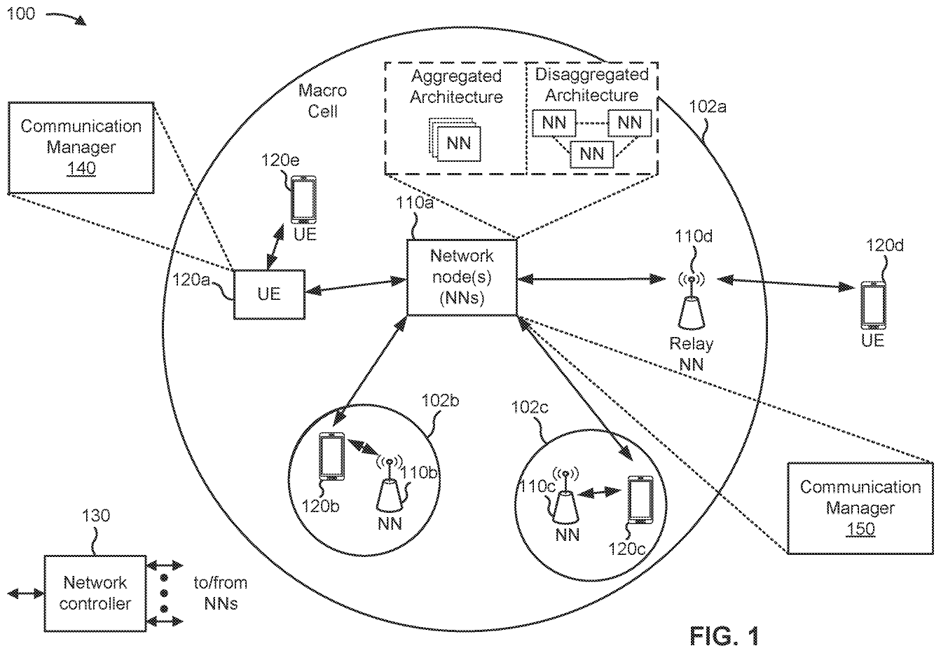

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

The electromagnetic spectrum is often subdivided, by frequency/wavelength, into various classes, bands, channels, etc. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., a UE 120) may include a communication manager 140. As described in more detail elsewhere herein, the communication manager 140 may receive first information corresponding to an active period of cell DTX or DRX operation and second information corresponding to a non-active period of the cell DTX or DRX operation. The communication manager 140 may rate match during the non-active period using the second information.

In some aspects, the communication manager 140 may receive a first gap measurement configuration for measurement during an active period of cell DTX or DRX operation of a first cell and a second gap measurement configuration for measurement during a non-active period of the cell DTX or DRX operation of the first cell. The communication manager 140 may measure, during the non-active period using the second gap measurement configuration, a signal of a second cell during a gap in signals of the first cell. Additionally, or alternatively, the communication manager 140 may perform one or more other operations described herein.

In some aspects, a network entity (e.g., a network node 110) may include a communication manager 150. As described in more detail elsewhere herein, the communication manager 150 may transmit first information for an active period of cell DTX or DRX operation and second information for a non-active period of the cell DTX or DRX operation. The communication manager 150 may rate match during the non-active period using the second information.

In some aspects, the communication manager 150 may transmit a first gap measurement configuration for measurement during an active period of cell DTX or DRX operation of a first cell and a second gap measurement configuration for measurement during a non-active period of the cell DTX or DRX operation of the first cell. The communication manager 150 may receive, after being in the non-active period, a measurement of a signal of a second cell. Additionally, or alternatively, the communication manager 150 may perform one or more other operations described herein.

As indicated above, FIG. 1 is provided as an example. Other examples may differ from what is described with regard to FIG. 1.

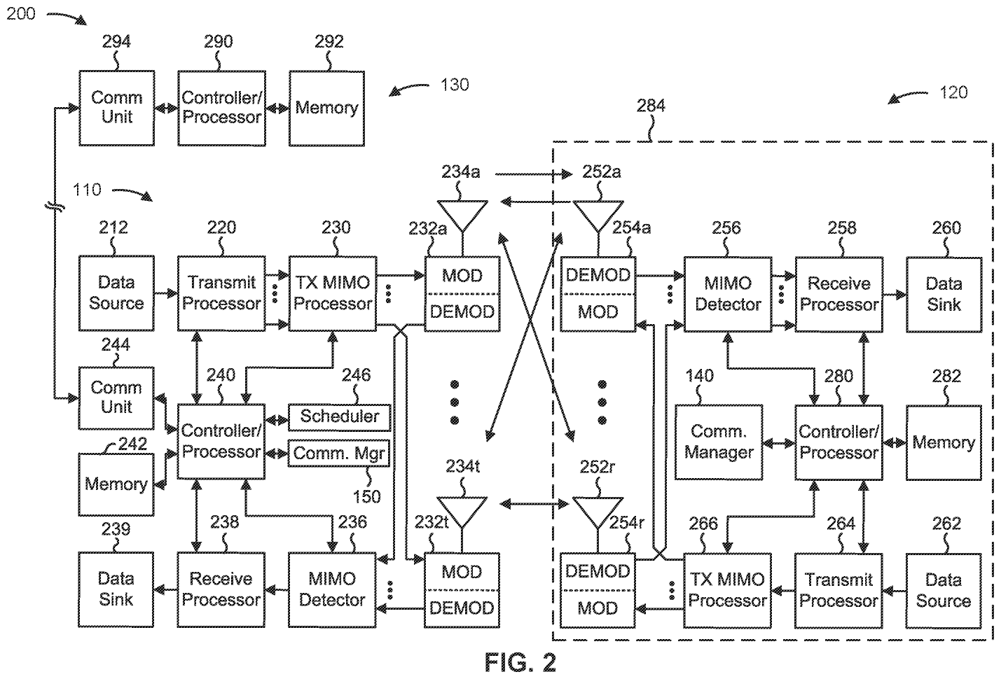

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

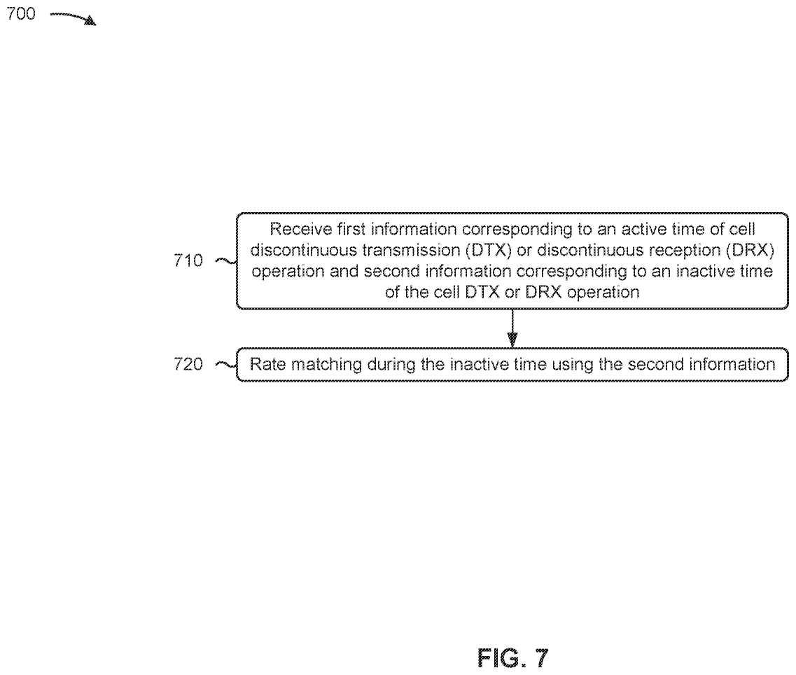

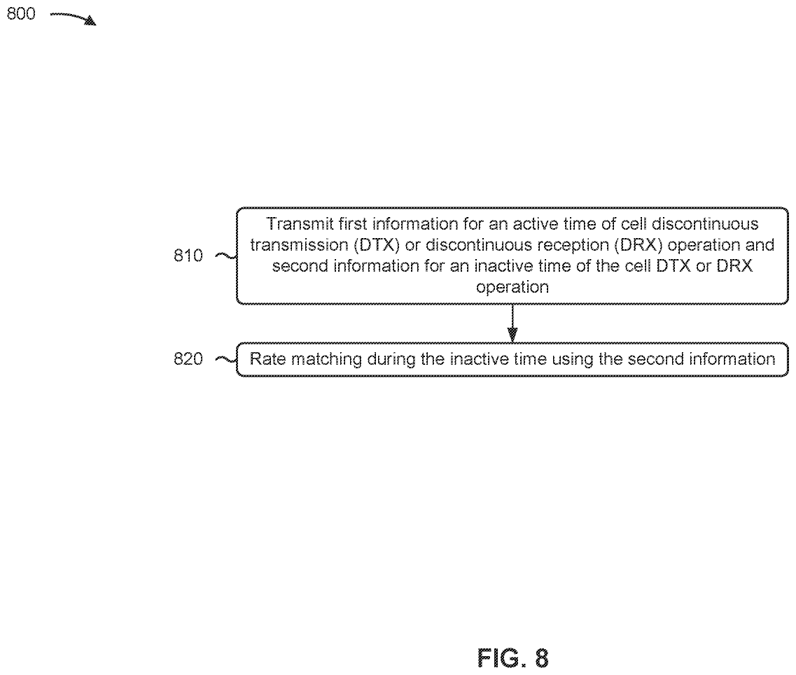

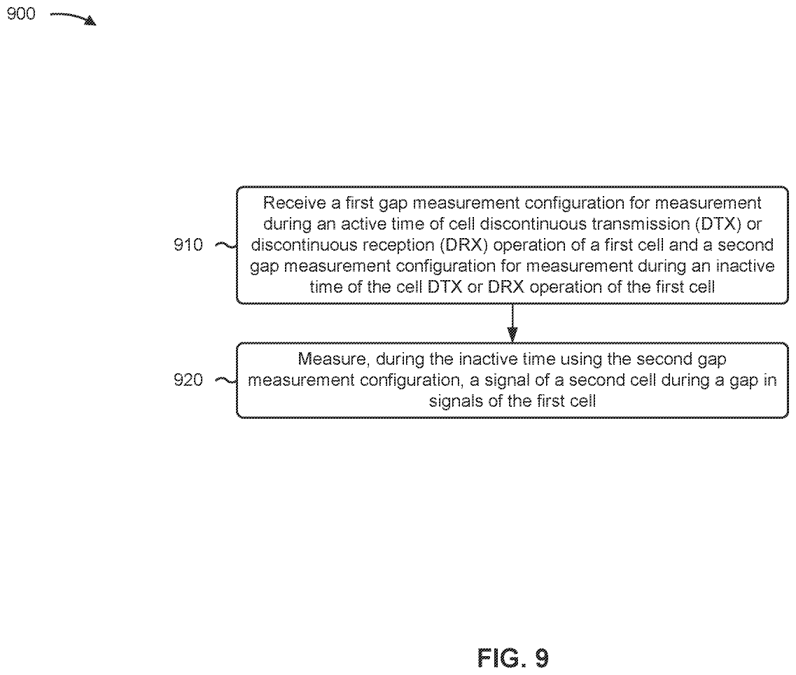

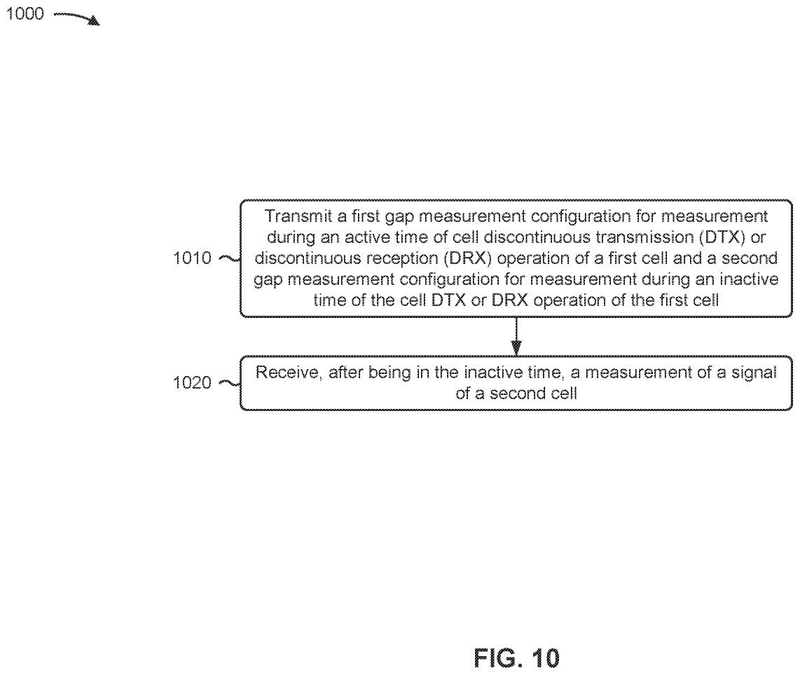

The controller/processor of a network entity (e.g., the controller/processor 240 of the network node 110), the controller/processor 280 of the UE 120, and/or any other component(s) of FIG. 2 may perform one or more techniques associated with switching configurations, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, a UE (e.g., a UE 120) includes means for receiving first information corresponding to an active period of cell DTX or DRX operation and second information corresponding to a non-active period of the cell DTX or DRX operation; and/or means for rate matching during the non-active period using the second information. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE includes means for receiving a first gap measurement configuration for measurement during an active period of cell DTX or DRX operation of a first cell and a second gap measurement configuration for measurement during a non-active period of the cell DTX or DRX operation of the first cell; and/or means for measuring, during the non-active period using the second gap measurement configuration, a signal of a second cell during a gap in signals of the first cell.

In some aspects, a network entity (e.g., a network node 110) includes means for transmitting first information for an active period of cell DTX or DRX operation and second information for a non-active period of the cell DTX or DRX operation; and/or means for rate matching during the non-active period using the second information. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the network entity includes means for transmitting a first gap measurement configuration for measurement during an active period of cell DTX or DRX operation of a first cell and a second gap measurement configuration for measurement during a non-active period of the cell DTX or DRX operation of the first cell; and/or means for receiving, after being in the non-active period, a measurement of a signal of a second cell.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

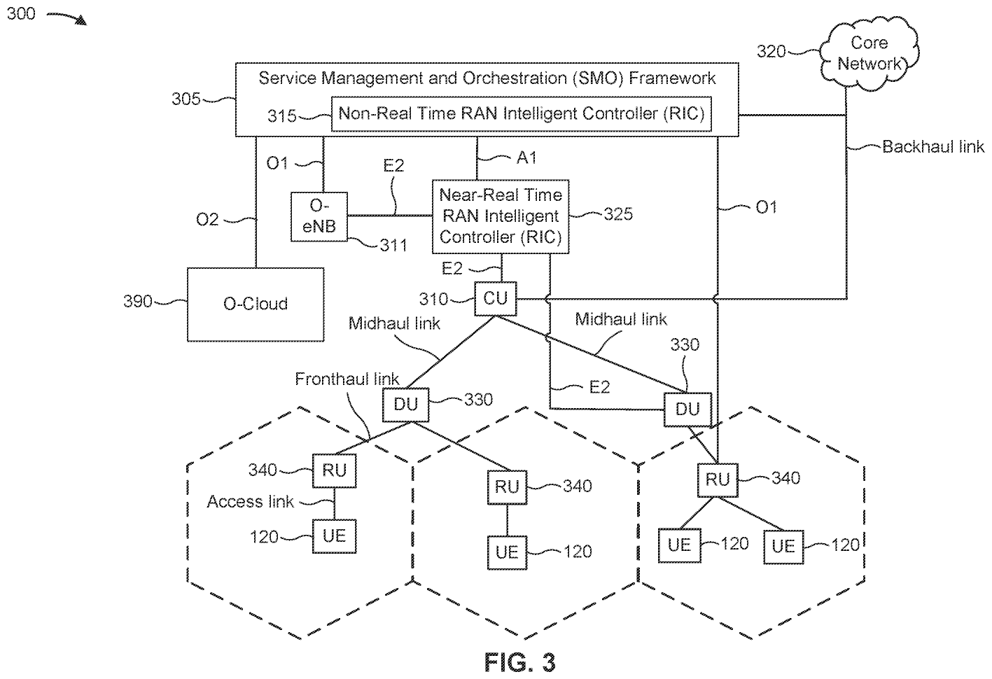

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

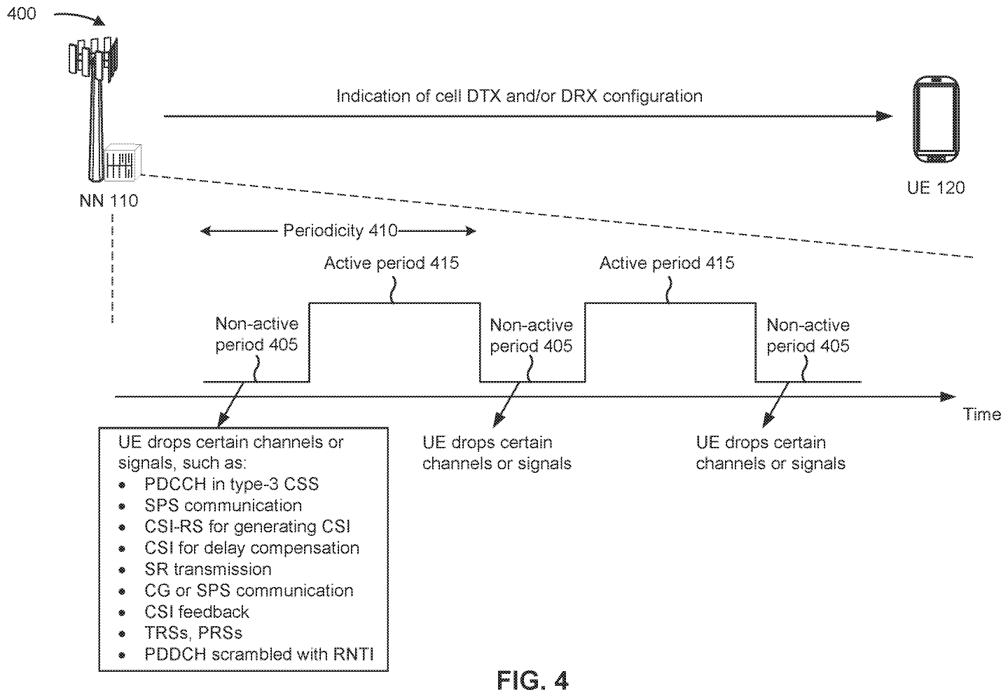

FIG. 4 is a diagram illustrating an example 400 of cell DTX and/or DRX, in accordance with the present disclosure. As shown in FIG. 4, example 400 includes a UE 120 in communication with a network entity (e.g., network node (NN) 110). In some examples, the UE 120 may be in a connected state (e.g., an RRC connected state) with the network node 110.

Power consumption is a large percentage of network costs, and most network power consumption comes from a RAN. A network entity (e.g., network node 110) of the RAN may operate to conserve power. In some examples, to conserve power, a network entity may use a cell DTX mode. A cell DTX mode includes periodic DTX cycles, where each DTX cycle includes an active period during which the network entity uses power for transmission and a non-active period during which the network entity reduces its power and does not transmit signals (or does not transmit certain signals). The network entity may also use a cell DRX mode that includes periodic DRX cycles, where each DRX cycle includes an active period during which the network entity uses power for monitoring and reception and a non-active period during which the network entity reduces its power and does not monitor for and receive signals (or does not receive certain signals). A UE may also operate in a DRX mode. A UE may align its DRX cycle with that of the cell DTX cycle.

As shown in example 400, the network node 110 may transmit an indication of a cell DTX and/or DRX configuration to the UE 120. The configuration may be for cell DTX, cell DRX, or both cell DTX and cell DRX. The configuration may indicate a non-active period 405 (which may also be referred to as an “uplink and/or downlink channel restriction window”) for the cycle. The configuration may indicate a starting time of the non-active period 405 (e.g., a time offset), a duration of the non-active period 405, and/or a periodicity 410 of the non-active period 405, among other examples. One or more types of physical channels or signals may be restricted during the non-active period 405 (e.g., a restricted channel or signal that is scheduled or configured during the non-active period 405 may be dropped by the network node 110 and/or the UE 120). The UE 120 may be expected to not transmit or receive particular channels or signals during the non-active period 405. In this way, the network node 110 may enter a sleep state during the non-active period 405. For example, for downlink communications, the UE may drop reception of a PDCCH in a type-3 CSS, an SPS communication, a CSI-RS for generating CSI, and/or a CSI-RS for propagation delay compensation, among other examples. Downlink channels or signals restricted during the non-active period 405 may include periodic and/or semi-persistent CSI-RSs (e.g., including tracking reference signals (TRSs)), (PRSs), PDCCH communications scrambled with a UE-specific radio network temporary identifier (RNTI), PDCCHs in a type-3 CSS (e.g., a group-common PDCCH), and/or SPS physical downlink shared channel (PDSCH) communications, among other examples. Additionally, or alternatively, for uplink communications, the UE may drop transmission of an SR, a CG communication, and/or CSI feedback, among other examples. Uplink channels or signals restricted during the non-active period 405 may include scheduling requests, periodic and/or semi-persistent CSI reports, periodic and/or semi-persistent sounding reference signals (SRSs), and/or CG physical uplink shared channel (PUSCH) communications, among other examples. As further shown, cell DTX and/or DRX may include active periods 415 outside of (e.g., between) non-active periods 405. Physical channel or signal restrictions applicable to the non-active period 405 may not be applicable to the active period 415.

In some examples, during the non-active period 405, the UE 120 may be expected to drop physical channels or signals associated with a minimal impact to UE implementation complexity or system performance. For example, in downlink, the UE 120 may drop reception of a PDCCH in a type-3 CSS, an SPS communication, a CSI-RS for generating CSI, and/or a CSI-RS for propagation delay compensation, among other examples. Additionally, or alternatively, in uplink, the UE 120 may drop transmission of a scheduling request, a CG communication, and/or CSI feedback, among other examples.

Because different channels or signals will be used or dropped during a non-active period of cell DTX/DRX operation (any non-active period of a cell DTX/DRX cycle), some operations may have different efficiencies during non-active period than during active period. One of these operations may include rate matching. Rate matching may involve adapting an output data rate of an encoder to match available resources for transmission in the time-frequency grid of resource elements of a physical downlink channel. Rate matching may include assigning data for transmission in a pattern of resource elements so as to avoid transmission in specific resource elements. The pattern may be a rate matching pattern. If rate matching is performed with the same rate matching pattern during a non-active period of cell DTX/DRX operation as during an active period of cell DTX/DRX operation, the rate matching during the non-active period may underuse or overuse resource elements because the rate matching may not account for dropped (e.g., not allowed or absent) signals or channels. Such inefficient resource allocation wastes signaling resources, reduces reliability, and increases latency.

As indicated above, FIG. 4 is provided as an example. Other examples may differ from what is described with regard to FIG. 4.

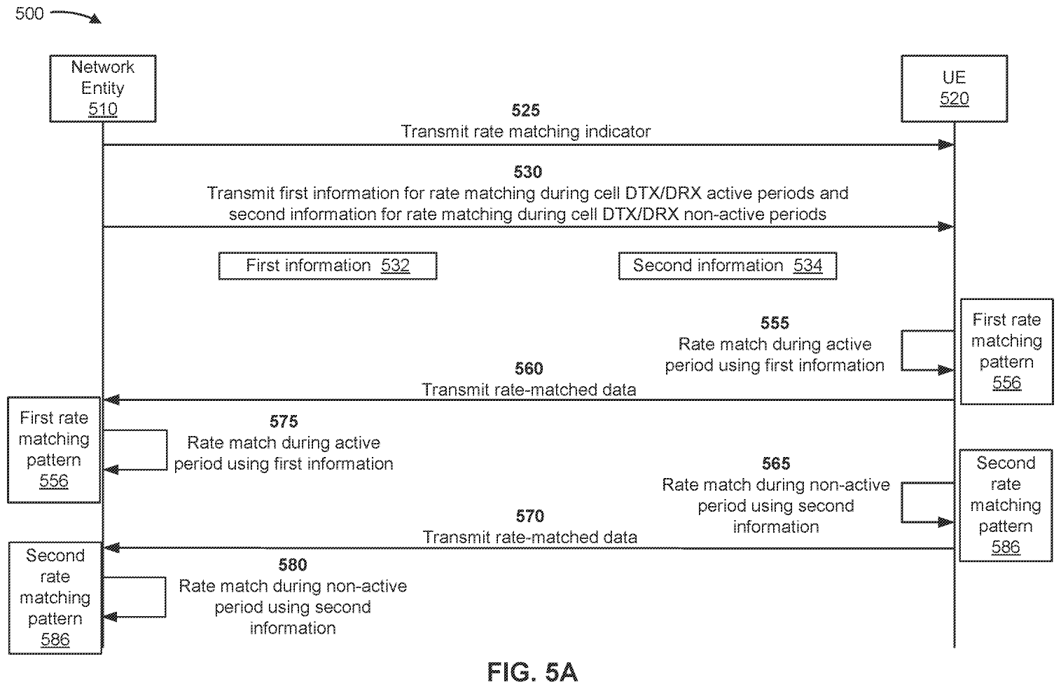

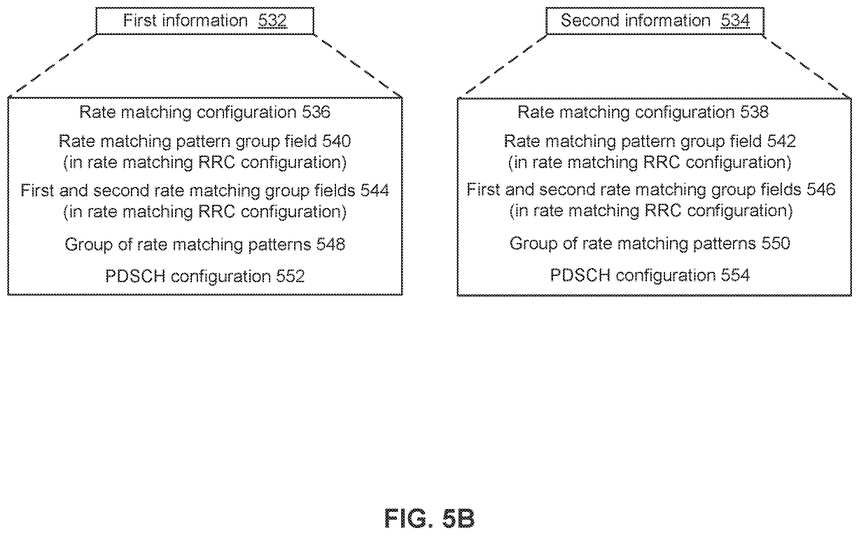

FIG. 5A and FIG. 5B are diagrams illustrating an example 500 of rate matching for a non-active period, in accordance with the present disclosure. Example 500 shows a network entity 510 (e.g., network node 110) and a UE 520 (e.g., a UE 120) that may communicate with one another via a wireless network (e.g., wireless network 100).

According to various aspects described herein, a UE may perform rate matching during a non-active period of cell DTX/DRX operation differently than during an active period of cell DTX/DRX. For example, the UE may receive information corresponding to an active period of cell DTX/DRX operation and second information corresponding to a non-active period of the cell DTX/DRX operation. The information may include, for example, rate matching configurations or groups of rate matching patterns (rate matching pattern groups). The UE may use the first information when rate matching during active periods and use the second information when rate matching during non-active periods. By rate matching during cell DTX/DRX non-active periods differently than during cell DTX/DRX non-active periods, the UE may improve reliability and improve resource allocation efficiency, which conserves signaling resources and avoids increasing latency.

Example 500 of FIG. 5A shows the use of different information for rate matching during non-active periods of cell DTX/DRX operation. As shown by reference number 525, the network entity 510 may transmit a rate matching indicator. In some aspects, the rate matching indicator may be included in downlink control information (DCI) and may indicate cell DTX or DRX active periods or cell DTX or DRX non-active periods. The DCI may indicate different values depending on whether the UE 520 is going to perform rate matching differently for non-active periods than for active periods. In some aspects, the rate matching indicator may be included in an information element (IE) and may indicate whether rate matching resources (e.g., rate matching pattern) will be the same or different between active periods and non-active periods.

As shown by reference number 530, the network entity 510 may transmit first information 532 for rate matching during cell DTX/DRX active periods and second information 534 for rate matching during cell DTX/DRX non-active periods. The first information and the second information may be different. In some aspects, as shown in FIG. 5B, the first information 532 may include a first rate matching configuration 536, and the second information 534 may include a second rate matching configuration 538. A rate matching configuration may indicate one or more rate matching patterns that correspond to a set of one or more signals and/or channels that are allowed or not allowed.

In some aspects, the first information 532 may include a first rate matching pattern group field 540 (value) in a rate matching RRC configuration, and the second information 534 may include a second rate matching pattern group field 542 (value) in the same rate matching RRC configuration. The field values may indicate one or more rate matching patterns or information about the rate matching patterns.

In some aspects, the first information 532 may include multiple rate matching pattern group fields (e.g., first and second group fields 544), and the second information 534 may include multiple rate matching pattern group fields (e.g., third and fourth group fields 546). In some aspects, the first information 532 may include a first group of rate matching patterns 548, and the second information 534 may include a second group of rate matching patterns 550. In some aspects, the first information 532 may indicate a first PDSCH configuration 552 (e.g., PDSCH-Config-Active), and the second information 534 may indicate a second PDSCH configuration 554 (e.g., PDSCH-Config-Inactive). A PDSCH configuration may include parameters for transmitting on a PDSCH.

As shown by reference number 555 in FIG. 5A, the UE 520 may rate match during an active period using the first information 532. As shown by reference number 560, the UE 520 may transmit the rate-matched data. As shown by reference number 565, the UE 520 may rate match during a non-active period using the second information 534. As shown by reference number 570, the UE 520 may transmit the rate-matched data. As shown by reference number 575, the network entity 510 may also rate match to decode the data during the active period using the first information. As shown by reference number 580, the network entity 510 may rate match to decode the data during the non-active period using the second information.

Example 500 shows that the UE 520 may perform rate matching during a non-active period of cell DTX/DRX operation differently than during an active period of cell DTX/DRX. The UE 520 may use a first rate matching pattern 556 during an active period and a second rate matching pattern 586 during a non-active period. The second rate matching pattern 586 is different than the first rate matching pattern 556. By treating rate matching differently during cell DTX/DRX active periods than cell DTX/DRX non-active periods, the UE 520 may improve resource allocation efficiency.

As indicated above, FIG. 5A and FIG. 5B are provided as an example. Other examples may differ from what is described with regard to FIG. 5A and FIG. 5B.

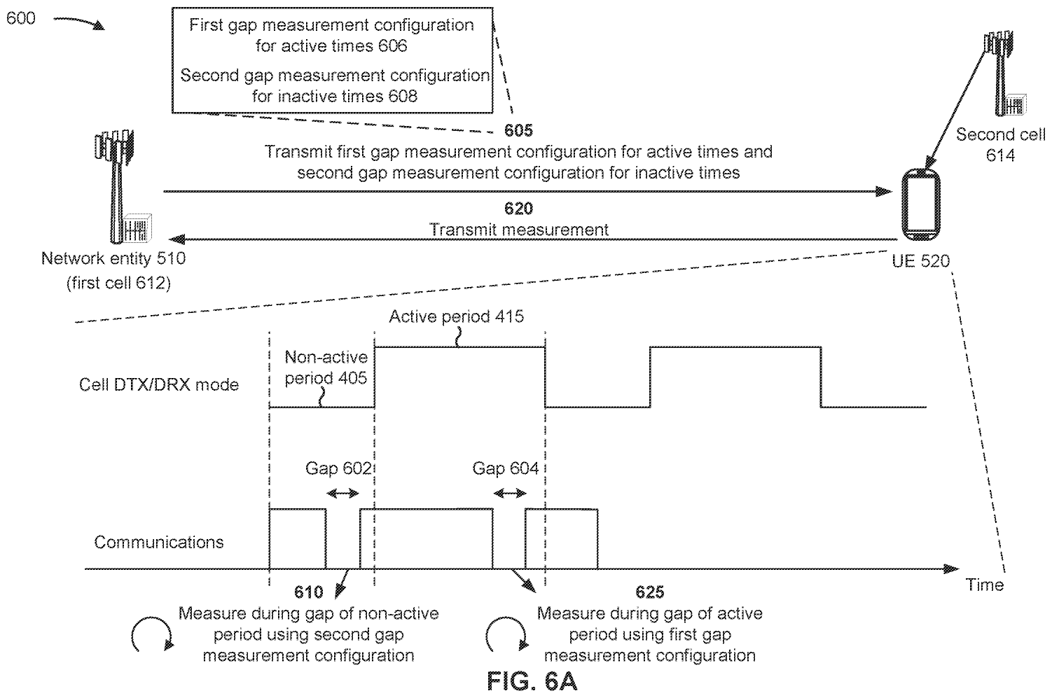

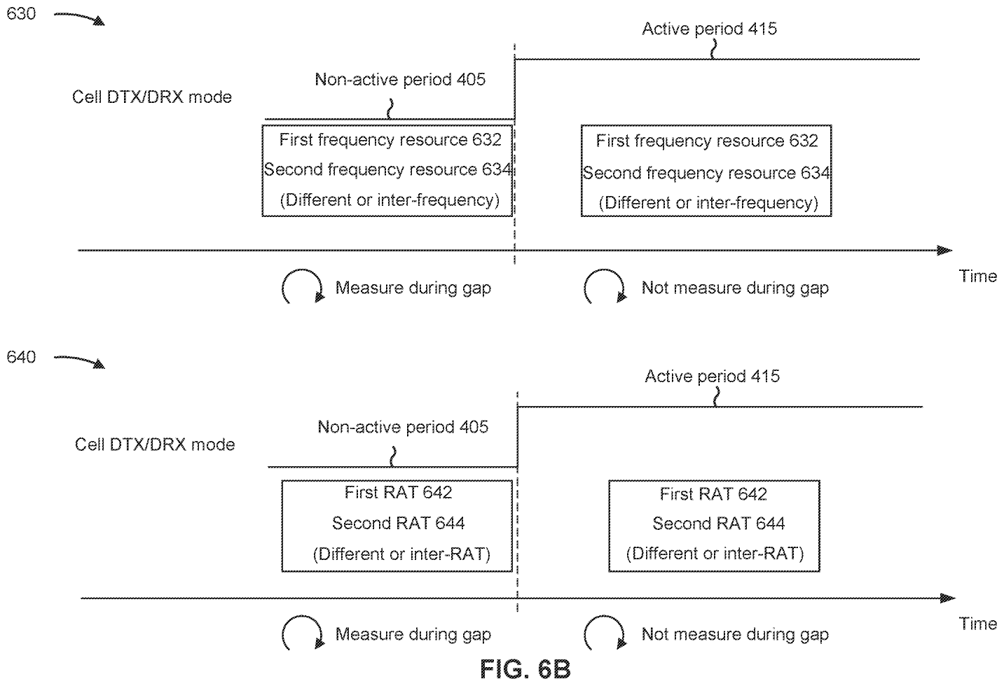

FIG. 6A and FIG. 6B are diagrams illustrating an example 600 of gap measurement, in accordance with the present disclosure.

In some scenarios, the UE 520 may obtain reference signal measurements from another cell during a gap in communications with the network entity 510. In some aspects, the UE 520 may perform gap measurements differently for cell DTX/DRX non-active periods than for cell DTX/DRX active periods. A gap measurement configuration may indicate when to take measurements, how many measurements, and/or what signals to measure (e.g., inter-frequency, intra-frequency, inter-RAT).

As shown by reference number 605 in FIG. 6A, the network entity 510 may transmit a first gap measurement configuration 606 for use during active periods and a second gap measurement configuration 608 to use during non-active periods. For example, the UE 520 may perform inter-frequency or inter-RAT measurements only during non-active periods as there may be no heavy interruption of data unlike during active periods. By using a different gap measurement configuration for non-active periods than for active periods, the UE 520 may account for different amounts of data interruptions and may obtain accurate measurements without being interrupted.

The network entity 510 may be associated with a first cell 612. As shown by reference number 610, the UE 520 may measure reference signals (e.g., CSI-RSs, synchronization signal blocks (SSBs)) of a second cell 614 during gap 602 of a non-active period 405 (that occurs before an active period 415). The UE 520 may use the second gap measurement configuration 608 during the non-active period 405. As shown by reference number 620, the UE 520 may transmit the measurement of the second cell 614 obtained during the gap 604. To illustrate the contrast between the use of the first gap measurement configuration 606 and the use of the second gap measurement configuration 608, the UE 520 may use the first gap measurement configuration 606 during a gap 604 of an active period 415, as shown by reference number 625.

FIG. 6B shows an example 630 of performing inter-frequency measurements only during non-active periods and an example 640 of performing inter-RAT measurements only during non-active periods. In some aspects, as shown by example 630, a frequency resource 632 associated with the first cell 612 (of network entity 510) and a frequency resource 634 associated with the second cell 614 are different (inter-frequency). The UE may perform inter-frequency measurements during the non-active period 405 and not during the active period 415.

In some aspects, as shown by example 640, the first cell 612 may be associated with a first RAT 642 and the second cell 614 may be associated with a second RAT 644. Measurements made with RATs that are different are considered to be inter-RAT. The UE may perform inter-RAT measurements during the non-active period 405 and not during the active period 415.

As indicated above, FIG. 6A and FIG. 6B are provided as examples. Other examples may differ from what is described with regard to FIG. 6A and FIG. 6B.

FIG. 7 is a diagram illustrating an example process 700 performed, for example, at a UE or an apparatus of a UE, in accordance with the present disclosure. Example process 700 is an example where the apparatus or the UE (e.g., UE 120, UE 520) performs operations associated with rate matching for cell DTX/DRX.

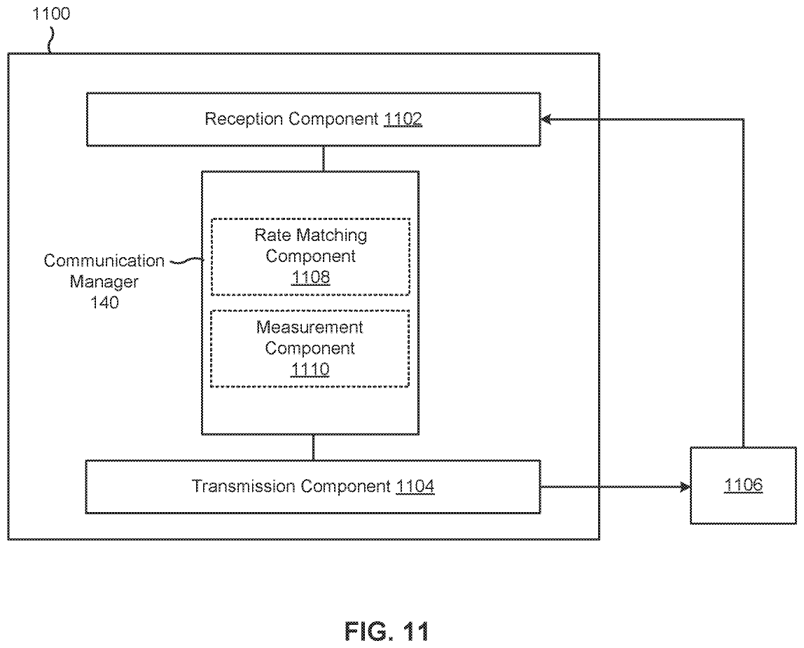

As shown in FIG. 7, in some aspects, process 700 may include receiving first information corresponding to an active period of cell DTX or DRX operation and second information corresponding to a non-active period of the cell DTX or DRX operation (block 710). For example, the UE (e.g., using communication manager 140 and/or reception component 1102, depicted in FIG. 11) may receive first information corresponding to an active period of cell DTX or DRX operation and second information corresponding to a non-active period of the cell DTX or DRX operation, as described above.

As further shown in FIG. 7, in some aspects, process 700 may include rating matching during the non-active period using the second information (block 720). For example, the UE (e.g., using communication manager 140 and/or rate matching component 1108, depicted in FIG. 11) may rate match during the non-active period using the second information, as described above.

Process 700 may include additional aspects, such as any single aspect or any combination of aspects described below and/or in connection with one or more other processes described elsewhere herein.

In a first aspect, the first information includes a first rate matching configuration corresponding to the active period and the second information includes a second rate matching configuration corresponding to the non-active period.

In a second aspect, alone or in combination with the first aspect, the first information includes a first rate matching pattern group field, in a rate matching RRC configuration, corresponding to the active period and a second rate matching pattern group field, in the rate matching RRC configuration, corresponding to the non-active period.

In a third aspect, alone or in combination with one or more of the first and second aspects, the first information includes a first rate matching pattern group field and a second rate matching group field corresponding to the active period and a third rate matching group field and a fourth rate matching pattern group field corresponding to the non-active period. The rate matching pattern group fields may be in a rate matching RRC configuration.

In a fourth aspect, alone or in combination with one or more of the first through third aspects, the first information indicates a first group of one or more rate matching patterns corresponding to the active period and a second group of one or more rate matching patterns corresponding to the non-active period.

In a fifth aspect, alone or in combination with one or more of the first through fourth aspects, process 700 includes receiving DCI indicating the active period or the non-active period.

In a sixth aspect, alone or in combination with one or more of the first through fifth aspects, process 700 includes receiving an information element, in a configuration for cell DRX or DTX, indicating whether rate matching resources are different between the active period and the non-active period.

In a seventh aspect, alone or in combination with one or more of the first through sixth aspects, the first information includes a first PDSCH configuration corresponding to the active period and the second information includes a second PDSCH configuration corresponding to the non-active period.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network entity or an apparatus of a network entity, in accordance with the present disclosure. Example process 800 is an example where the apparatus or the network entity (e.g., network node 110, network entity 510) performs operations associated with rate matching for cell DTX/DRX.

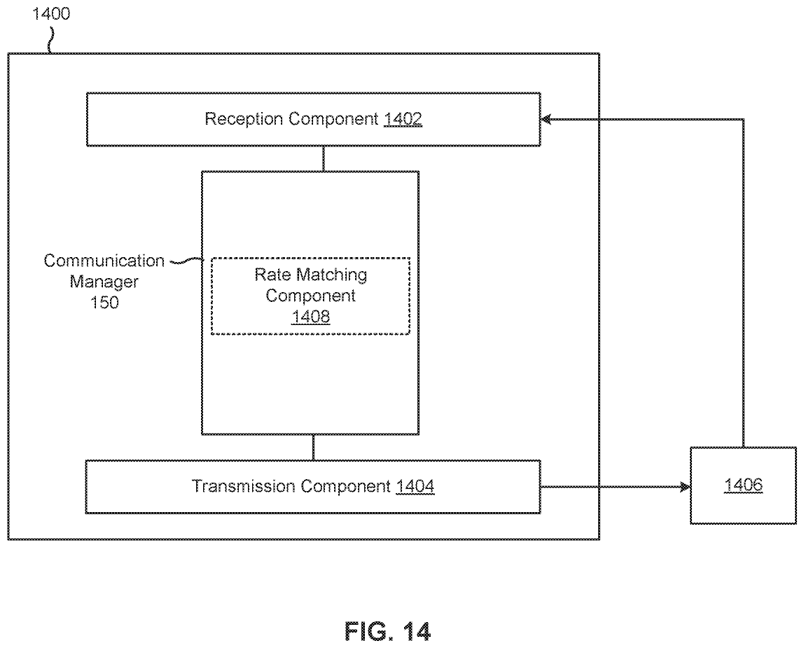

As shown in FIG. 8, in some aspects, process 800 may include transmitting first information for an active period of cell DTX or DRX operation and second information for a non-active period of the cell DTX or DRX operation (block 810). For example, the network entity (e.g., using communication manager 150 and/or transmission component 1404, depicted in FIG. 14) may transmit first information for an active period of cell DTX or DRX operation and second information for a non-active period of the cell DTX or DRX operation, as described above.

As further shown in FIG. 8, in some aspects, process 800 may include rate matching during the non-active period using the second information (block 820). For example, the network entity (e.g., using communication manager 150 and/or rate matching component 1408, depicted in FIG. 14) may rate match during the non-active period using the second information, as described above.

Process 800 may include additional aspects, such as any single aspect or any combination of aspects described below and/or in connection with one or more other processes described elsewhere herein.

In a first aspect, process 800 includes rating matching in the active period using the first information.

In a second aspect, alone or in combination with the first aspect, the first information includes a first rate matching configuration corresponding to the active period and the second information includes a second rate matching configuration corresponding to the non-active period.

In a third aspect, alone or in combination with one or more of the first and second aspects, the first information includes a first rate matching pattern group field, in a rate matching RRC configuration, corresponding to the active period and a second rate matching pattern group field, in the rate matching RRC configuration, corresponding to the non-active period.

In a fourth aspect, alone or in combination with one or more of the first through third aspects, the first information includes a first rate matching pattern group field and a second rate matching group field corresponding to the active period and a third rate matching group field and a fourth rate matching pattern group field corresponding to the non-active period. The rate matching pattern group fields may be in a rate matching RRC configuration.

In a fifth aspect, alone or in combination with one or more of the first through fourth aspects, the first information indicates a first group of one or more rate matching patterns corresponding to the active period and a second group of one or more rate matching patterns corresponding to the non-active period.

In a sixth aspect, alone or in combination with one or more of the first through fifth aspects, process 800 includes transmitting DCI indicating the active period or the non-active period.

In a seventh aspect, alone or in combination with one or more of the first through sixth aspects, process 800 includes transmitting an information element, in a configuration for cell DRX or DTX, indicating whether first rate matching resources associated with the active period are different than second rate matching resources associated with the non-active period.

In an eighth aspect, alone or in combination with one or more of the first through seventh aspects, the first information includes a first PDSCH configuration corresponding to the active period and the second information includes a second PDSCH configuration corresponding to the non-active period.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a UE or an apparatus of a UE, in accordance with the present disclosure. Example process 900 is an example where the apparatus or the UE (e.g., UE 120, UE 520) performs operations associated with rate matching for cell DTX/DRX.

As shown in FIG. 9, in some aspects, process 900 may include receiving a first gap measurement configuration for measurement during an active period of cell DTX or DRX operation of a first cell and a second gap measurement configuration for measurement during a non-active period of the cell DTX or DRX operation of the first cell (block 910). For example, the UE (e.g., using communication manager 140 and/or reception component 1102, depicted in FIG. 11) may receive a first gap measurement configuration for measurement during an active period of cell DTX or DRX operation of a first cell and a second gap measurement configuration for measurement during a non-active period of the cell DTX or DRX operation of the first cell, as described above.

As further shown in FIG. 9, in some aspects, process 900 may include measuring, during the non-active period using the second gap measurement configuration, a signal of a second cell during a gap in signals of the first cell (block 920). For example, the UE (e.g., using communication manager 150 and/or measurement component 1110, depicted in FIG. 11) may measure, during the non-active period using the second gap measurement configuration, a signal of a second cell during a gap in signals of the first cell, as described above.

Process 900 may include additional aspects, such as any single aspect or any combination of aspects described below and/or in connection with one or more other processes described elsewhere herein.

In a first aspect, a frequency resource associated with the first cell is a same frequency resource as a frequency resource associated with the second cell.

In a second aspect, alone or in combination with the first aspect, a frequency resource associated with the first cell and a frequency resource associated with the second cell are different.

In a third aspect, alone or in combination with one or more of the first and second aspects, the first cell is associated with a first radio access technology and the second cell is associated with a second radio access technology.

In a fourth aspect, alone or in combination with one or more of the first through third aspects, process 900 includes measuring, in the active period, a signal of the second cell during a gap using the first gap measurement configuration.

In a fifth aspect, alone or in combination with one or more of the first through fourth aspects, the signal of the second cell is a synchronization signal block.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network entity or an apparatus of a network entity, in accordance with the present disclosure. Example process 1000 is an example where the apparatus or the network entity (e.g., network node 110, network entity 510) performs operations associated with rate matching for cell DTX/DRX.

As shown in FIG. 10, in some aspects, process 1000 may include transmitting a first gap measurement configuration for measurement during an active period of cell DTX or DRX operation of a first cell and a second gap measurement configuration for measurement during a non-active period of the cell DTX or DRX operation of the first cell (block 1010). For example, the network entity (e.g., using communication manager 150 and/or transmission component 1404, depicted in FIG. 14) may transmit a first gap measurement configuration for measurement during an active period of cell DTX or DRX operation of a first cell and a second gap measurement configuration for measurement during a non-active period of the cell DTX or DRX operation of the first cell, as described above.

As further shown in FIG. 10, in some aspects, process 1000 may include receiving, after being in the non-active period, a measurement of a signal of a second cell (block 1020). For example, the network entity (e.g., using communication manager 150 and/or reception component 1402, depicted in FIG. 14) may receive, after being in the non-active period, a measurement of a signal of a second cell, as described above.

Process 1000 may include additional aspects, such as any single aspect or any combination of aspects described below and/or in connection with one or more other processes described elsewhere herein.

In a first aspect, a frequency resource associated with the first cell and a frequency resource associated with the second cell are the same.

In a second aspect, alone or in combination with the first aspect, a frequency resource associated with the first cell and a frequency resource associated with the second cell are different.

In a third aspect, alone or in combination with one or more of the first and second aspects, the first cell is associated with a first RAT and the second cell is associated with a second RAT.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 140 may include a rate matching component 1108 and/or a measurement component 1110, among other examples.

In some aspects, the apparatus 1100 may be configured to perform one or more operations described herein in connection with FIGS. 1-6. Additionally, or alternatively, the apparatus 1100 may be configured to perform one or more processes described herein, such as process 700 of FIG. 7 and process 900 of FIG. 9. In some aspects, the apparatus 1100 and/or one or more components shown in FIG. 11 May include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1104 may be co-located with the reception component 1102 in one or more transceivers.

In some aspects, the reception component 1102 may receive first information corresponding to an active period of cell DTX or DRX operation and second information corresponding to a non-active period of the cell DTX or DRX operation. The rate matching component 1108 may rate match during the non-active period using the second information.

In some aspects, the reception component 1102 may receive a first gap measurement configuration for measurement during an active period of cell DTX or DRX operation of a first cell and a second gap measurement configuration for measurement during a non-active period of the cell DTX or DRX operation of the first cell. The measurement component 1110 may measuring, during the non-active period using the second gap measurement configuration, a signal of a second cell during a gap in signals of the first cell.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

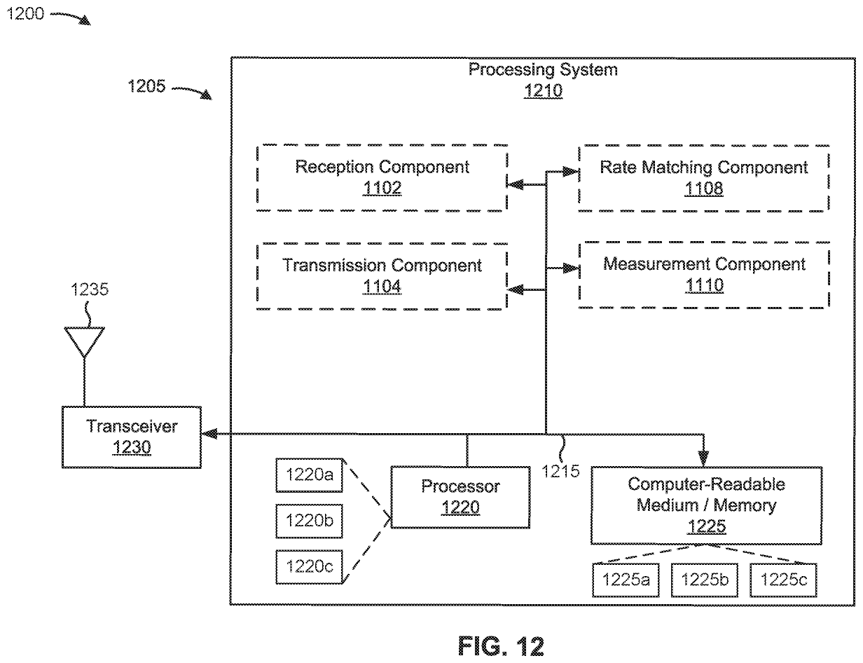

FIG. 12 is a diagram illustrating an example 1200 of a hardware implementation for an apparatus 1205 employing a processing system 1210, in accordance with the present disclosure. The apparatus 1205 may be a UE or may be at (e.g., included in) a UE.

The processing system 1210 may be implemented with a bus architecture, represented generally by the bus 1215. The bus 1215 may include any number of interconnecting buses and bridges depending on the specific application of the processing system 1210 and the overall design constraints. The bus 1215 links together various circuits including one or more processors and/or hardware components, represented by the processor (or processing circuitry) 1220, the illustrated components, and the computer-readable medium/memory (or memory circuitry) 1225. The processor 1220 may include multiple processors, such as processor 1220a, memory 1220b, and memory 1220c. The memory 1225 may include multiple memories, such as memory 1225a, memory 1225b, and memory 1225c. The bus 1215 may also link various other circuits, such as timing sources, peripherals, voltage regulators, and/or power management circuits.

The processing system 1210 may be coupled to one or more transceivers 1230. A transceiver 1230 is coupled to one or more antennas 1235. The transceiver 1230 provides a means for communicating with various other apparatuses over a transmission medium. The transceiver 1230 receives a signal from the one or more antennas 1235, extracts information from the received signal, and provides the extracted information to the processing system 1210, specifically the reception component 1102. In addition, the transceiver 1230 receives information from the processing system 1210, specifically the transmission component 1104, and generates a signal to be applied to the one or more antennas 1235 based at least in part on the received information.

The processing system 1210 includes one or more processors 1220 coupled to a computer-readable medium/memory 1225. A processor 1220 is responsible for general processing, including the execution of software stored on the computer-readable medium/memory 1225. The software, when executed by the processor 1220, causes the processing system 1210 to perform the various functions described herein for any particular apparatus. The computer-readable medium/memory 1225 may also be used for storing data that is manipulated by the processor 1220 when executing software.

The processing system further includes at least one of the illustrated components. The components may be software modules running in the processor 1220, resident/stored in the computer readable medium/memory 1225, one or more hardware modules coupled to the processor 1220, or some combination thereof.

In some aspects, the processing system 1210 may be a component of the UE 120 and may include one or more memories, such as the memory 282, and/or may include one or more processors, such as at least one of the TX MIMO processor 266, the receive (RX) processor 258, and/or the controller/processor 280. In some aspects, the apparatus 1205 for wireless communication includes means for receiving first information corresponding to an active period of cell DTX or DRX operation and second information corresponding to a non-active period of the cell DTX or DRX operation; and/or means for rate matching during the non-active period using the second information. In some aspects, the apparatus 1205 for wireless communication includes means for receiving a first gap measurement configuration for measurement during an active period of cell DTX or DRX operation of a first cell and a second gap measurement configuration for measurement during a non-active period of the cell DTX or DRX operation of the first cell; and/or means for measuring, during the non-active period using the second gap measurement configuration, a signal of a second cell during a gap in signals of the first cell. The aforementioned means may be one or more of the aforementioned components of the apparatus 1100 and/or the processing system 1210 of the apparatus 1205 configured to perform the functions recited by the aforementioned means. As described elsewhere herein, the processing system 1210 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 12 is provided as an example. Other examples may differ from what is described in connection with FIG. 12.

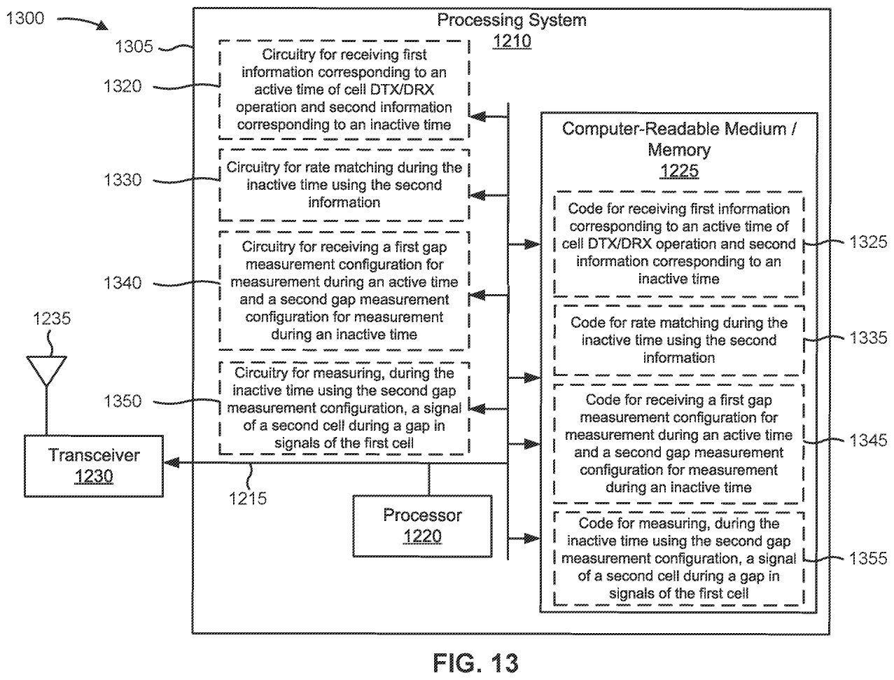

FIG. 13 is a diagram illustrating an example 1300 of an implementation of code and circuitry for an apparatus 1305, in accordance with the present disclosure. The circuitry may include processing circuitry and memory circuitry. The apparatus 1305 may be a UE, or a UE may include the apparatus 1305.

As shown in FIG. 13, the apparatus 1305 may include circuitry for receiving first information corresponding to an active period of cell DTX or DRX operation and second information corresponding to a non-active period of the cell DTX or DRX operation (circuitry 1320). For example, the circuitry 1320 may enable the apparatus 1305 to cause the transceiver 1230 to receive first information corresponding to an active period of cell DTX or DRX operation and second information corresponding to a non-active period of the cell DTX or DRX operation.

As shown in FIG. 13, the apparatus 1305 may include, stored in computer-readable medium 1225, code for receiving first information corresponding to an active period of cell DTX or DRX operation and second information corresponding to a non-active period of the cell DTX or DRX operation (code 1325). For example, the code 1325, when executed by processor 1220, may cause processor 1220 to cause the transceiver 1230 to receive first information corresponding to an active period of cell DTX or DRX operation and second information corresponding to a non-active period of the cell DTX or DRX operation.

As shown in FIG. 13, the apparatus 1305 may include circuitry for rate matching during the non-active period using the second information (circuitry 1330). For example, the circuitry 1330 may enable the apparatus 1305 to rate match during the non-active period using the second information.

As shown in FIG. 13, the apparatus 1305 may include, stored in computer-readable medium 1225, code for rate matching during the non-active period using the second information (code 1335). For example, the code 1335, when executed by processor 1220, may cause processor 1220 to rate match during the non-active period using the second information.

As shown in FIG. 13, the apparatus 1305 may include circuitry for receiving a first gap measurement configuration for measurement during an active period of cell DTX or DRX operation of a first cell and a second gap measurement configuration for measurement during a non-active period of the cell DTX or DRX operation of the first cell (circuitry 1340). For example, the circuitry 1340 may enable the apparatus 1305 to cause the transceiver 1230 to receive a first gap measurement configuration for measurement during an active period of cell DTX or DRX operation of a first cell and a second gap measurement configuration for measurement during a non-active period of the cell DTX or DRX operation of the first cell.

As shown in FIG. 13, the apparatus 1305 may include, stored in computer-readable medium 1225, code for receiving a first gap measurement configuration for measurement during an active period of cell DTX or DRX operation of a first cell and a second gap measurement configuration for measurement during a non-active period of the cell DTX or DRX operation of the first cell (code 1345). For example, the code 1345, when executed by processor 1220, may cause processor 1220 to cause the transceiver 1230 to receive a first gap measurement configuration for measurement during an active period of cell DTX or DRX operation of a first cell and a second gap measurement configuration for measurement during a non-active period of the cell DTX or DRX operation of the first cell.

As shown in FIG. 13, the apparatus 1305 may include circuitry for measuring, during the non-active period using the second gap measurement configuration, a signal of a second cell during a gap in signals of the first cell (circuitry 1350). For example, the circuitry 1350 may enable the apparatus 1305 to measure, during the non-active period using the second gap measurement configuration, a signal of a second cell during a gap in signals of the first cell.

As shown in FIG. 13, the apparatus 1305 may include, stored in computer-readable medium 1225, code for measuring, during the non-active period using the second gap measurement configuration, a signal of a second cell during a gap in signals of the first cell (code 1355). For example, the code 1335, when executed by processor 1220, may cause processor 1220 to measure, during the non-active period using the second gap measurement configuration, a signal of a second cell during a gap in signals of the first cell.

FIG. 13 is provided as an example. Other examples may differ from what is described in connection with FIG. 13.

FIG. 14 is a diagram of an example apparatus 1400 for wireless communication, in accordance with the present disclosure. The apparatus 1400 may be a network entity, or a network entity may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 150. The communication manager 150 may include a rate matching component 1408, among other examples.

In some aspects, the apparatus 1400 may be configured to perform one or more operations described herein in connection with FIGS. 1-6. Additionally, or alternatively, the apparatus 1400 may be configured to perform one or more processes described herein, such as process 800 of FIG. 8 and process 1000 of FIG. 10. In some aspects, the apparatus 1400 and/or one or more components shown in FIG. 14 may include one or more components of the network entity described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, one or more modems, one or more demodulators, one or more MIMO detectors, one or more receive processors, one or more controllers/processors, one or more memories, or a combination thereof, of the network entity described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, one or more modems, one or more modulators, one or more transmit MIMO processors, one or more transmit processors, one or more controllers/processors, one or more memories, or a combination thereof, of the network entity described in connection with FIG. 2. In some aspects, the transmission component 1404 may be co-located with the reception component 1402 in one or more transceivers.

In some aspects, the transmission component 1404 may transmit first information for an active period of cell DTX or DRX operation and second information for a non-active period of the cell DTX or DRX operation. The rate matching component 1408 may rate match during the non-active period using the second information.

In some aspects, the transmission component 1404 may transmit a first gap measurement configuration for measurement during an active period of cell DTX or DRX operation of a first cell and a second gap measurement configuration for measurement during a non-active period of the cell DTX or DRX operation of the first cell. The reception component 1402 may receive, after being in the non-active period, a measurement of a signal of a second cell.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

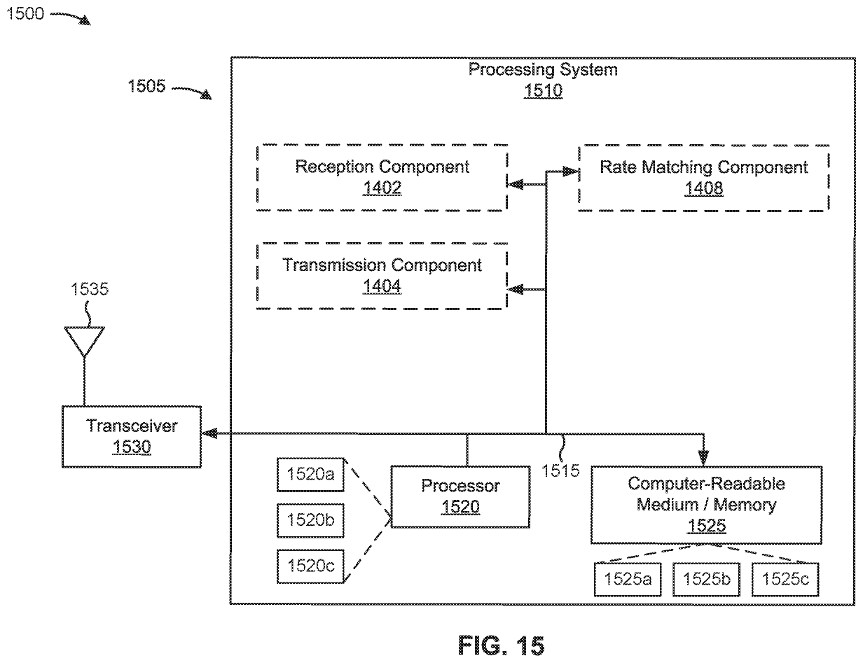

FIG. 15 is a diagram illustrating an example 1500 of a hardware implementation for an apparatus 1505 employing a processing system 1510, in accordance with the present disclosure. The apparatus 1505 may be a network entity or may be at (e.g., included in) a network entity.

The processing system 1510 may be implemented with a bus architecture, represented generally by the bus 1515. The bus 1515 may include any number of interconnecting buses and bridges depending on the specific application of the processing system 1510 and the overall design constraints. The bus 1515 links together various circuits including one or more processors and/or hardware components, represented by the processor (or processing circuitry) 1520, the illustrated components, and the computer-readable medium/memory (or memory circuitry) 1525. The processor 1520 may include multiple processors, such as processor 1520a, memory 1520b, and memory 1520c. The memory 1525 may include multiple memories, such as memory 1525a, memory 1525b, and memory 1525c. The bus 1515 may also link various other circuits, such as timing sources, peripherals, voltage regulators, and/or power management circuits.

The processing system 1510 may be coupled to one or more transceivers 1530. A transceiver 1530 is coupled to one or more antennas 1535. The transceiver 1530 provides a means for communicating with various other apparatuses over a transmission medium. The transceiver 1530 receives a signal from the one or more antennas 1535, extracts information from the received signal, and provides the extracted information to the processing system 1510, specifically the reception component 1402. In addition, the transceiver 1530 receives information from the processing system 1510, specifically the transmission component 1404, and generates a signal to be applied to the one or more antennas 1535 based at least in part on the received information.

The processing system 1510 includes one or more processors 1520 coupled to a computer-readable medium/memory 1525. A processor 1520 is responsible for general processing, including the execution of software stored on the computer-readable medium/memory 1525. The software, when executed by the processor 1520, causes the processing system 1510 to perform the various functions described herein for any particular apparatus. The computer-readable medium/memory 1525 may also be used for storing data that is manipulated by the processor 1520 when executing software. The processing system further includes at least one of the illustrated components. The components may be software modules running in the processor 1520, resident/stored in the computer readable medium/memory 1525, one or more hardware modules coupled to the processor 1520, or some combination thereof.

In some aspects, the processing system 1510 may be a component of the network node 110 and may include one or more memories, such as the memory 242, and/or may include one or more processors, such as at least one of the TX MIMO processor 230, the RX processor 238, and/or the controller/processor 240. In some aspects, the apparatus 1505 for wireless communication includes means for transmitting first information for an active period of cell DTX or DRX operation and second information for a non-active period of the cell DTX or DRX operation; and/or means for rate matching during the non-active period using the second information. In some aspects, the apparatus 1505 for wireless communication includes means for transmitting a first gap measurement configuration for measurement during an active period of cell DTX or DRX operation of a first cell and a second gap measurement configuration for measurement during a non-active period of the cell DTX or DRX operation of the first cell; and/or means for receiving, after being in the non-active period, a measurement of a signal of a second cell. The aforementioned means may be one or more of the aforementioned components of the apparatus 1400 and/or the processing system 1510 of the apparatus 1505 configured to perform the functions recited by the aforementioned means. As described elsewhere herein, the processing system 1510 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 15 is provided as an example. Other examples may differ from what is described in connection with FIG. 15.

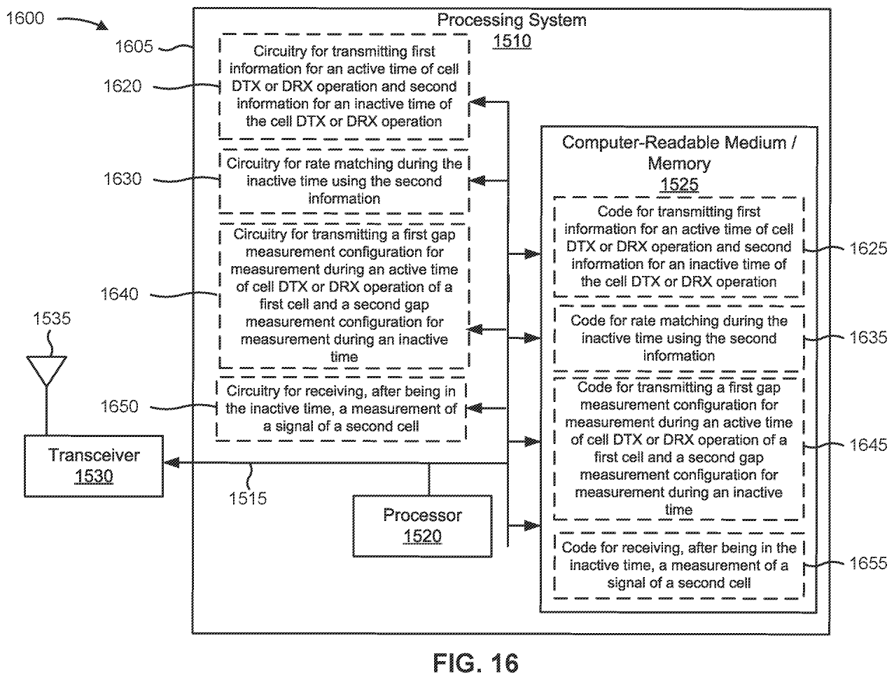

FIG. 16 is a diagram illustrating an example 1600 of an implementation of code and circuitry for an apparatus 1605, in accordance with the present disclosure. The apparatus 1605 may be a network entity, or a network entity may include the apparatus 1605.

As shown in FIG. 16, the apparatus 1605 may include circuitry for transmitting first information for an active period of cell DTX or DRX operation and second information for a non-active period of the cell DTX or DRX operation (circuitry 1620). For example, the circuitry 1620 may enable the apparatus 1605 to cause the transceiver 1530 to transmit first information for an active period of cell DTX or DRX operation and second information for a non-active period of the cell DTX or DRX operation.

As shown in FIG. 16, the apparatus 1605 may include, stored in computer-readable medium 1525, code for transmitting first information for an active period of cell DTX or DRX operation and second information for a non-active period of the cell DTX or DRX operation (code 1625). For example, the code 1625, when executed by processor 1520, may cause processor 1520 to cause the transceiver 1530 to transmit first information for an active period of cell DTX or DRX operation and second information for a non-active period of the cell DTX or DRX operation.

As shown in FIG. 16, the apparatus 1605 may include circuitry for rate matching during the non-active period using the second information (circuitry 1630). For example, the circuitry 1630 may enable the apparatus 1605 to rate match during the non-active period using the second information.

As shown in FIG. 16, the apparatus 1605 may include, stored in computer-readable medium 1525, code for rate matching during the non-active period using the second information (code 1635). For example, the code 1635, when executed by processor 1520, may cause processor 1520 to rate match during the non-active period using the second information.

As shown in FIG. 16, the apparatus 1605 may include circuitry for transmitting a first gap measurement configuration for measurement during an active period of cell DTX or DRX operation of a first cell and a second gap measurement configuration for measurement during a non-active period of the cell DTX or DRX operation of the first cell (circuitry 1640). For example, the circuitry 1640 may enable the apparatus 1605 to cause the transceiver 1530 to transmit a first gap measurement configuration for measurement during an active period of cell DTX or DRX operation of a first cell and a second gap measurement configuration for measurement during a non-active period of the cell DTX or DRX operation of the first cell.

As shown in FIG. 16, the apparatus 1605 may include, stored in computer-readable medium 1525, code for transmitting a first gap measurement configuration for measurement during an active period of cell DTX or DRX operation of a first cell and a second gap measurement configuration for measurement during a non-active period of the cell DTX or DRX operation of the first cell (code 1645). For example, the code 1645, when executed by processor 1520, may cause processor 1520 to cause the transceiver 1530 to transmit a first gap measurement configuration for measurement during an active period of cell DTX or DRX operation of a first cell and a second gap measurement configuration for measurement during a non-active period of the cell DTX or DRX operation of the first cell.

As shown in FIG. 16, the apparatus 1605 may include circuitry for receiving, after being in the non-active period, a measurement of a signal of a second cell (circuitry 1650). For example, the circuitry 1650 may enable the apparatus 1605 to cause the transceiver 1530 to receive, after being in the non-active period, a measurement of a signal of a second cell.

As shown in FIG. 16, the apparatus 1605 may include, stored in computer-readable medium 1525, code for receiving, after being in the non-active period, a measurement of a signal of a second cell (code 1655). For example, the code 1655, when executed by processor 1520, may cause processor 1520 to cause the transceiver 1530 to receive, after being in the non-active period, a measurement of a signal of a second cell.

FIG. 16 is provided as an example. Other examples may differ from what is described in connection with FIG. 16.

The following provides an overview of some Aspects of the present disclosure:
Aspect 1: A method of wireless communication performed at a user equipment (UE), comprising: receiving first information corresponding to an active period of cell discontinuous transmission (DTX) or discontinuous reception (DRX) operation and second information corresponding to a non-active period of the cell DTX or DRX operation; and rate matching during the non-active period using the second information.
Aspect 2: The method of Aspect 1, wherein the first information includes a first rate matching configuration corresponding to the active period and the second information includes a second rate matching configuration corresponding to the non-active period.
Aspect 3: The method of any of Aspects 1-2, wherein the first information includes a first rate matching pattern group field, in a rate matching radio resource control (RRC) configuration, corresponding to the active period and a second rate matching pattern group field, in the rate matching RRC configuration, corresponding to the non-active period.
Aspect 4: The method of any of Aspects 1-3, wherein the first information includes a first rate matching pattern group field and a second rate matching group field, in a rate matching radio resource control (RRC) configuration, corresponding to the active period and a third rate matching group field and a fourth rate matching pattern group field, in the rate matching RRC configuration, corresponding to the non-active period.
Aspect 5: The method of any of Aspects 1-4, wherein the first information indicates a first group of one or more rate matching patterns corresponding to the active period and a second group of one or more rate matching patterns corresponding to the non-active period.
Aspect 6: The method of any of Aspects 1-5, further comprising receiving downlink control information (DCI) indicating the active period or the non-active period.
Aspect 7: The method of any of Aspects 1-6, further comprising receiving an information element, in a configuration for cell DRX or DTX, indicating whether rate matching resources are different between the active period and the non-active period.
Aspect 8: The method of any of Aspects 1-7, wherein the first information includes a first physical downlink shared channel (PDSCH) configuration corresponding to the active period and the second information includes a second PDSCH configuration corresponding to the non-active period.
Aspect 9: A method of wireless communication performed at a network entity, comprising: transmitting first information for an active period of cell discontinuous transmission (DTX) or discontinuous reception (DRX) operation and second information for a non-active period of the cell DTX or DRX operation; and rate matching during the non-active period using the second information.
Aspect 10: The method of Aspect 9, further comprising rate matching in the active period using the first information.
Aspect 11: The method of any of Aspects 9-10, wherein the first information includes a first rate matching configuration corresponding to the active period and the second information includes a second rate matching configuration corresponding to the non-active period.
Aspect 12: The method of any of Aspects 9-11, wherein the first information includes a first rate matching pattern group field, in a rate matching radio resource control (RRC) configuration, corresponding to the active period and a second rate matching pattern group field, in the rate matching RRC configuration, corresponding to the non-active period.
Aspect 13: The method of any of Aspects 9-12, wherein the first information includes a first rate matching pattern group field and a second rate matching group field, in a rate matching radio resource control (RRC) configuration, corresponding to the active period and a third rate matching group field and a fourth rate matching pattern group field, in the rate matching RRC configuration, corresponding to the non-active period.
Aspect 14: The method of any of Aspects 9-13, wherein the first information indicates a first group of one or more rate matching patterns corresponding to the active period and a second group of one or more rate matching patterns corresponding to the non-active period.
Aspect 15: The method of any of Aspects 9-14, further comprising transmitting downlink control information (DCI) indicating the active period or the non-active period.
Aspect 16: The method of any of Aspects 9-15, further comprising transmitting an information element, in a configuration for cell DRX or DTX, indicating whether first rate matching resources associated with the active period are different than second rate matching resources associated with the non-active period.
Aspect 17: The method of any of Aspects 9-16, wherein the first information includes a first physical downlink shared channel (PDSCH) configuration corresponding to the active period and the second information includes a second PDSCH configuration corresponding to the non-active period.
Aspect 18: A method of wireless communication performed at a user equipment (UE), comprising: receiving a first gap measurement configuration for measurement during an active period of cell discontinuous transmission (DTX) or discontinuous reception (DRX) operation of a first cell and a second gap measurement configuration for measurement during a non-active period of the cell DTX or DRX operation of the first cell; and measuring, during the non-active period using the second gap measurement configuration, a signal of a second cell during a gap in signals of the first cell.
Aspect 19: The method of Aspect 18, wherein a frequency resource associated with the first cell is a same frequency resource as a frequency resource associated with the second cell.
Aspect 20: The method of Aspect 18, wherein a frequency resource associated with the first cell and a frequency resource associated with the second cell are different.
Aspect 21: The method of any of Aspects 18-20, wherein the first cell is associated with a first radio access technology and the second cell is associated with a second radio access technology.
Aspect 22: The method of any of Aspects 18-21, further comprising measuring, in the active period, a signal of the second cell during a gap using the first gap measurement configuration.
Aspect 23: The method of any of Aspects 18-22, wherein the signal of the second cell is a synchronization signal block.
Aspect 24: A method of wireless communication performed at a network entity, comprising: transmitting a first gap measurement configuration for measurement during an active period of cell discontinuous transmission (DTX) or discontinuous reception (DRX) operation of a first cell and a second gap measurement configuration for measurement during a non-active period of the cell DTX or DRX operation of the first cell; and receiving, after being in the non-active period, a measurement of a signal of a second cell.
Aspect 25: The method of Aspect 24, wherein a frequency resource associated with the first cell and a frequency resource associated with the second cell are the same.
Aspect 26: The method of any of Aspects 24-25, wherein a frequency resource associated with the first cell and a frequency resource associated with the second cell are different.
Aspect 27: The method of any of Aspects 24-26, wherein the first cell is associated with a first radio access technology and the second cell is associated with a second radio access technology.
Aspect 28: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-27.
Aspect 29: An apparatus for wireless communication at a device, the apparatus comprising one or more memories and one or more processors coupled to the one or more memories, the one or more processors configured to cause the device to perform the method of one or more of Aspects 1-27.
Aspect 30: An apparatus for wireless communication, the apparatus comprising at least one means for performing the method of one or more of Aspects 1-27.
Aspect 31: A non-transitory computer-readable medium storing code for wireless communication, the code comprising instructions executable by one or more processors to perform the method of one or more of Aspects 1-27.
Aspect 32: A non-transitory computer-readable medium storing a set of instructions for wireless communication, the set of instructions comprising one or more instructions that, when executed by one or more processors of a device, cause the device to perform the method of one or more of Aspects 1-27.
Aspect 33: A device for wireless communication, the device comprising a processing system that includes one or more processors and one or more memories coupled with the one or more processors, the processing system configured to cause the device to perform the method of one or more of Aspects 1-27.
Aspect 34: An apparatus for wireless communication at a device, the apparatus comprising one or more memories and one or more processors coupled to the one or more memories, the one or more processors individually or collectively configured to cause the device to perform the method of one or more of Aspects 1-27.
Aspect 37: An apparatus for wireless communication at a device, the apparatus comprising one or more memories and one or more processors coupled to the one or more memories, the one or more processors individually or collectively configured to cause the device to perform the method of one or more of Aspects 1-27.
Aspect 38: An apparatus for wireless communication at a user equipment (UE), comprising: a processing system that includes processor circuitry and memory circuitry that stores code and is coupled with the processor circuitry, the processing system configured to cause the UE to perform the method of one or more of Aspects 1-8 and 18-23.
Aspect 39: An apparatus for wireless communication at a network entity, comprising: a processing system that includes processor circuitry and memory circuitry that stores code and is coupled with the processor circuitry, the processing system configured to cause the network entity to perform the method of one or more of Aspects 9-17 and 24-27.
Aspect 40: An apparatus for wireless communication at a user equipment (UE), comprising: one or more memories; and one or more processors coupled to the one or more memories, the one or more processors configured to cause the UE to: receive first information corresponding to an active period of cell discontinuous transmission (DTX) or discontinuous reception (DRX) operation and second information corresponding to a non-active period of the cell DTX or DRX operation; and rate match during the non-active period using the second information.
Aspect 41: The apparatus of Aspect 40, wherein the one or more processors are configured, individually or collectively, to cause the UE to: receive first information corresponding to an active period of cell discontinuous transmission (DTX) or discontinuous reception (DRX) operation and second information corresponding to a non-active period of the cell DTX or DRX operation; and rate match during the non-active period using the second information.
Aspect 42: An apparatus for wireless communication at a network entity, comprising: one or more memories; and one or more processors coupled to the one or more memories, the one or more processors configured to cause the network entity to: transmit first information for an active period of cell discontinuous transmission (DTX) or discontinuous reception (DRX) operation and second information for a non-active period of the cell DTX or DRX operation; and rate match during the non-active period using the second information.
Aspect 43: The apparatus of Aspect 42, wherein the one or more processors are configured, individually or collectively, to cause the network entity to: transmit first information for an active period of cell discontinuous transmission (DTX) or discontinuous reception (DRX) operation and second information for a non-active period of the cell DTX or DRX operation; and rate match during the non-active period using the second information.
Aspect 44: An apparatus for wireless communication at a user equipment (UE), comprising: one or more memories; and one or more processors coupled to the one or more memories, the one or more processors configured to cause the UE to: receive a first gap measurement configuration for measurement during an active period of cell discontinuous transmission (DTX) or discontinuous reception (DRX) operation of a first cell and a second gap measurement configuration for measurement during a non-active period of the cell DTX or DRX operation of the first cell; and measure, during the non-active period using the second gap measurement configuration, a signal of a second cell during a gap in signals of the first cell.
Aspect 45: The apparatus of Aspect 44, wherein the one or more processors are configured, individually or collectively, to cause the UE to: receive a first gap measurement configuration for measurement during an active period of cell discontinuous transmission (DTX) or discontinuous reception (DRX) operation of a first cell and a second gap measurement configuration for measurement during a non-active period of the cell DTX or DRX operation of the first cell; and measure, during the non-active period using the second gap measurement configuration, a signal of a second cell during a gap in signals of the first cell.
Aspect 46: An apparatus for wireless communication at a network entity, comprising: one or more memories; and one or more processors coupled to the one or more memories, the one or more processors configured to cause the network entity to: transmit a first gap measurement configuration for measurement during an active period of cell discontinuous transmission (DTX) or discontinuous reception (DRX) operation of a first cell and a second gap measurement configuration for measurement during a non-active period of the cell DTX or DRX operation of the first cell; and receive, after being in the non-active period, a measurement of a signal of a second cell.
Aspect 47: The apparatus of Aspect 46, wherein the one or more processors are configured, individually or collectively, to cause the network entity to: transmit a first gap measurement configuration for measurement during an active period of cell discontinuous transmission (DTX) or discontinuous reception (DRX) operation of a first cell and a second gap measurement configuration for measurement during a non-active period of the cell DTX or DRX operation of the first cell; and receive, after being in the non-active period, a measurement of a signal of a second cell.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
one or more memories; and
one or more processors, coupled to the one or more memories, configured to cause the UE to:
receive first information corresponding to an active period of cell discontinuous transmission (DTX) or discontinuous reception (DRX) operation and second information corresponding to a non-active period of the cell DTX or DRX operation; and
rate match during the non-active period using the second information.

2. The apparatus of claim 1, wherein the first information includes a first rate matching configuration corresponding to the active period and the second information includes a second rate matching configuration corresponding to the non-active period.

3. The apparatus of claim 1, wherein the first information includes a first rate matching pattern group field, in a rate matching radio resource control (RRC) configuration, corresponding to the active period and a second rate matching pattern group field, in the rate matching RRC configuration, corresponding to the non-active period.

4. The apparatus of claim 1, wherein the first information includes a first rate matching pattern group field and a second rate matching group field, in a rate matching radio resource control (RRC) configuration, corresponding to the active period and a third rate matching group field and a fourth rate matching pattern group field, in the rate matching RRC configuration, corresponding to the non-active period.

5. The apparatus of claim 1, wherein the first information indicates a first group of one or more rate matching patterns corresponding to the active period and a second group of one or more rate matching patterns corresponding to the non-active period.

6. The apparatus of claim 1, wherein the one or more processors are further configured to cause the UE to receive downlink control information (DCI) indicating the active period or the non-active period.

7. The apparatus of claim 1, wherein the one or more processors are further configured to cause the UE to receive an information element, in a configuration for cell DRX or DTX, indicating whether rate matching resources are different between the active period and the non-active period.

8. The apparatus of claim 1, wherein the first information includes a first physical downlink shared channel (PDSCH) configuration corresponding to the active period and the second information includes a second PDSCH configuration corresponding to the non-active period.

9. An apparatus for wireless communication at a network entity, comprising:
one or more memories; and
one or more processors, coupled to the one or more memories, configured to cause the network entity to:
transmit first information for an active period of cell discontinuous transmission (DTX) or discontinuous reception (DRX) operation and second information for a non-active period of the cell DTX or DRX operation; and
rate match during the non-active period using the second information.

10. The apparatus of claim 9, wherein the one or more processors are further configured to cause the network entity to rate match in the active period using the first information.

11. The apparatus of claim 9, wherein the first information includes a first rate matching configuration corresponding to the active period and the second information includes a second rate matching configuration corresponding to the non-active period.

12. The apparatus of claim 9, wherein the first information includes a first rate matching pattern group field, in a rate matching radio resource control (RRC) configuration, corresponding to the active period and a second rate matching pattern group field, in the rate matching RRC configuration, corresponding to the non-active period.

13. The apparatus of claim 9, wherein the first information includes a first rate matching pattern group field and a second rate matching group field, in a rate matching radio resource control (RRC) configuration, corresponding to the active period and a third rate matching group field and a fourth rate matching pattern group field, in the rate matching RRC configuration, corresponding to the non-active period.

14. The apparatus of claim 9, wherein the first information indicates a first group of one or more rate matching patterns corresponding to the active period and a second group of one or more rate matching patterns corresponding to the non-active period.

15. The apparatus of claim 9, wherein the one or more processors are further configured to cause the network entity to transmit downlink control information (DCI) indicating the active period or the non-active period.

16. The apparatus of claim 9, wherein the one or more processors are further configured to cause the network entity to transmit an information element, in a configuration for cell DRX or DTX, indicating whether first rate matching resources associated with the active period are different than second rate matching resources associated with the non-active period.

17. The apparatus of claim 9, wherein the first information includes a first physical downlink shared channel (PDSCH) configuration corresponding to the active period and the second information includes a second PDSCH configuration corresponding to the non-active period.

18. An apparatus for wireless communication at a user equipment (UE), comprising:
one or more memories; and
one or more processors, coupled to the one or more memories, configured to cause the UE to:
receive a first gap measurement configuration for measurement during an active period of cell discontinuous transmission (DTX) or discontinuous reception (DRX) operation of a first cell and a second gap measurement configuration for measurement during a non-active period of the cell DTX or DRX operation of the first cell; and
measure, during the non-active period using the second gap measurement configuration, a signal of a second cell during a gap in signals of the first cell.

19. The apparatus of claim 18, wherein a frequency resource associated with the first cell is a same frequency resource as a frequency resource associated with the second cell.

20. The apparatus of claim 18, wherein a frequency resource associated with the first cell and a frequency resource associated with the second cell are different.

21. The apparatus of claim 18, wherein the first cell is associated with a first radio access technology and the second cell is associated with a second radio access technology.

22. The apparatus of claim 18, wherein the one or more processors are further configured to cause the UE to measure, in the active period, a signal of the second cell during a gap using the first gap measurement configuration.

23. The apparatus of claim 18, wherein the signal of the second cell is a synchronization signal block.

24. An apparatus for wireless communication at a network entity, comprising:
one or more memories; and
one or more processors, coupled to the one or more memories, configured to cause the network entity to:
transmit a first gap measurement configuration for measurement during an active period of cell discontinuous transmission (DTX) or discontinuous reception (DRX) operation of a first cell and a second gap measurement configuration for measurement during a non-active period of the cell DTX or DRX operation of the first cell; and
receive, after being in the non-active period, a measurement of a signal of a second cell.

25. The apparatus of claim 24, wherein a frequency resource associated with the first cell and a frequency resource associated with the second cell are the same.

26. The apparatus of claim 24, wherein a frequency resource associated with the first cell and a frequency resource associated with the second cell are different.

27. The apparatus of claim 24, wherein the first cell is associated with a first radio access technology and the second cell is associated with a second radio access technology.
